(19) United States
(12) Patent Application Publication
(10) Pub. No.: US 2026/0366867 A1
(43) Pub. Date: Nov. 19, 2026

(54) APPARATUS AND A METHOD FOR ALIGNMENT

(71) Applicant: OPTOFIDELITY OY, Tampere (FI)

(72) Inventors: Thomas KERST, Tampere (FI); Riina HIETIKKO, Tampere (FI); Jani AHVENJARVI, Tampere (FI); Ilkka ALASAARELA, Tampere (FI); Aleksi JOLANKI, Tampere (FI); Lauri LAARA, Tampere (FI); Jaakko HANNUKAINEN, Tampere (FI); Minna LINDELL, Tampere (FI); David ZAUTASVILI, Tampere (FI)

(21) Appl. No.: 19/143,079

(22) PCT Filed: Dec. 11, 2023
(86) PCT No.: PCT/FI2023/050677

§ 371 Date: Jun. 25, 2025

Related U.S. Application Data
(60) Provisional application No. 63/477,854, filed on Dec. 30, 2022.

(51) Int. Cl. G01B 11/27; G02B 27/62

(52) U.S. Cl. CPC G01B 11/272; G02B 27/62

(57) ABSTRACT

The invention relates to a method for alignment by an apparatus (1). The method comprises determining a reference axis (8) by a reference body (4); aligning at least one aligning device (5a, 5b) with respect to the reference axis (8); and aligning another device (2) separate from the at least one aligning device (5a, 5b) with respect to at least one aligning device (5a, 5b).

### TECHNICAL FIELD

There is provided a method for alignment and an apparatus.

### BACKGROUND

Detecting devices capable of detecting electromagnetic radiation have been used in different kinds of testing arrangement. For example, a detecting device have been used to test optical properties of waveguides, e.g., so that the waveguide is radiated with light and the detecting device is used to detect light reflected and/or transferred by the waveguide. Hence, the detecting device output can be used to evaluate some optical properties of the waveguide.

However, if the detecting device is not properly aligned with a proper location, the results may be distorted and erroneous. Due to tight accuracy requirements of the location of the detecting device there is a need to calibrate the location of the detecting device with enough accuracy.

### SUMMARY

There is provided a method for alignment of a device and an apparatus which comprises at least one aligning device. The at least one aligning device may be used, for example, in an arrangement to calibrate a position of one or more devices of a testing apparatus. This kind of calibration may also be called as alignment. Alignment of the at least one aligning device is performed by utilising a reference body, which is a part of arrangement for determining a reference axis.

In accordance with an embodiment, the apparatus also comprises a detecting device. The detecting device may be used, for example, in an arrangement used for testing sample which is capable of transferring and/or reflecting electromagnetic radiation but also other implementations are possible. The invention is based on the idea that an alignment arrangement comprises a reference body, at least one aligning device, and one or more adjustment devices for adjusting a location of the at least one aligning device with respect to a virtual reference axis defined by the reference body.

According to a first aspect there is provided a method for an apparatus comprising at least one aligning device, the method comprising determining a reference axis by a reference body; aligning at least one aligning device with respect to the reference axis; and aligning another device separate from the at least one aligning device with respect to the at least one aligning device.

According to a second aspect there is provided an apparatus comprising at least one aligning device, the apparatus is configured to determine a reference axis by a reference body; to align at least one aligning device with respect to the reference axis; and to align another device separate from the at least one aligning device with respect to the at least one aligning device.

Some advantageous embodiments are defined in the dependent claims.

The present invention may improve the calibration procedure which may also improve quality of testing of electromagnetic radiation transferring devices.

### BRIEF DESCRIPTION OF THE DRAWINGS

FIG. 1 shows as a simplified manner a testing arrangement, in accordance with an embodiment;

FIGS. 2a to 2d show as a simplified manner a principle of a calibration procedure in the testing arrangement of FIG. 1, in accordance with an embodiment;

FIG. 3 shows as a simplified block diagram a control device for controlling the testing arrangement, in accordance with an embodiment;

FIG. 4a shows a flow diagram of a method for alignment, in accordance with an embodiment;

FIG. 4b shows as a flow diagram some details of alignment of a detecting device, in accordance with an embodiment;

FIG. 4c shows a flow diagram of a method for alignment, in accordance with another embodiment;

FIG. 5 illustrates an embodiment in which position of one or more of the aligning devices is changed after determining a alignment axis; and

FIG. 6a illustrates in a simplified manner some details of the aligning device in accordance with an embodiment; and

FIG. 6b illustrates in a simplified manner some details of the aligning device in accordance with another embodiment.

### DETAILED DESCRIPTION

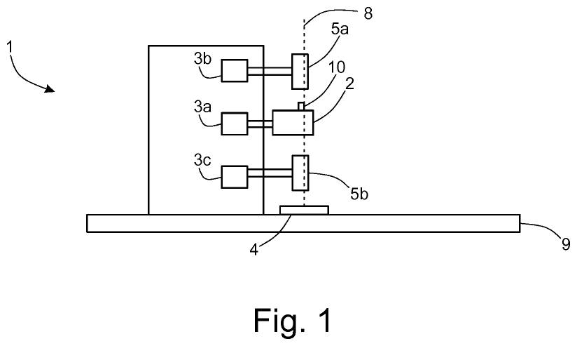

FIG. 1 shows as a simplified manner a testing arrangement 1, in accordance with an embodiment. The arrangement comprises a detecting device 2 and a first actuator 3a for moving the detecting device 2. The arrangement also comprises a reference body 4 to be used in the alignment procedure as an emitter of collimated radiation such as light. There is also a first aligning device 5a controlled by a second actuator 3b and a second aligning device 5b controlled by a third actuator 3c. There may also be a platform 9 onto which different elements of the testing arrangement can be attached with.

The reference body 4 may produce collimated light and/or reflect light which is directed towards the reference body 4 from another light source.

It should be noted that the term light is used in several locations in this description as an example of electromagnetic radiation, but also electromagnetic radiation at wavelengths different from typical light may be used instead or additionally.

It should also be noted that for clarity, the elements such as the actuators 3a-3d are only illustrated as simple blocks but in practical implementations they may take different forms.

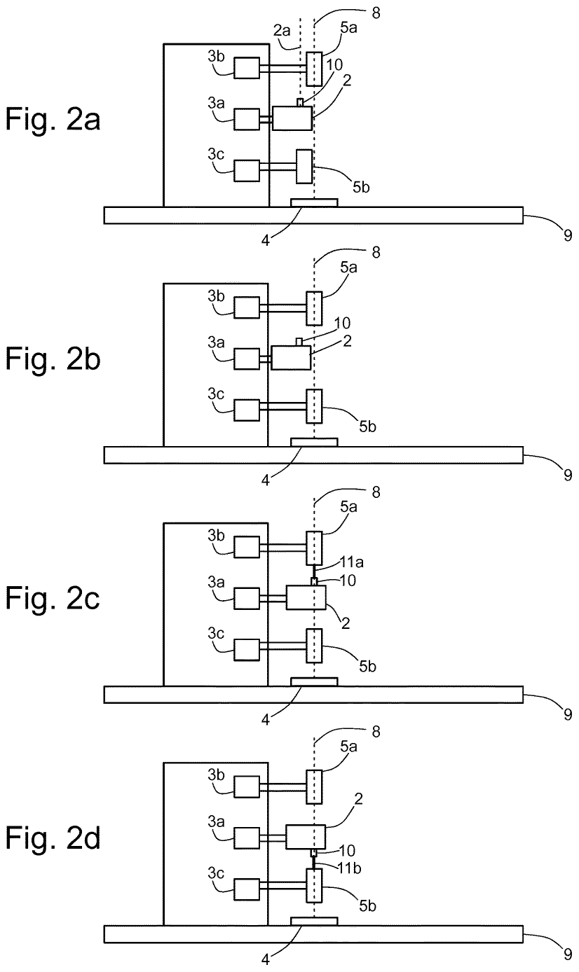

The reference body 4 is an element of the unit or a module of the unit or a part of a module of the unit that defines a reference axis 8. The reference axis 8 is not necessarily any concrete element but a virtual axis or a beam of electromagnetic radiation such as light. If the reference body 4 reflects light such as a mirror, a beam of electromagnetic radiation such as a collimated light beam may be projected to the reference body 4 which then reflects the beam to a certain direction. In the example of FIG. 1 and FIGS. 2a to 2d the direction is vertical, upwards from the reference body 4 but other directions may also be used such as a horizontal direction or some other direction which is neither horizontal nor vertical. In accordance with an embodiment, more than one reference axis 8 are determined, which may be a vertical and a horizontal reference axis, for example. In the following, only the vertical reference axis 8 is considered.

The detecting device 2 is an element of a unit or a module of the unit or a part of a module of the unit that is to be brought into a defined relationship with the reference body 4. The relationship may be established via a detecting device axis 2a, which is defined by the detecting device 2.

The aligning devices 5 are elements that are not necessarily elements of unit or modules of the unit or parts of the modules of the unit, which facilitate the bringing about of the defined relationship between the reference body 4 and the detecting device 2. The facilitating of this defined relationship with the aligning devices 5 may or may not involve the reference axis 8 and/or the detecting device axis 2a.

The aligning devices 5 comprise at least one, preferably at least two (or more) individual, not necessarily identical, aligning units 5a, 5b, which may be referred as the first aligning device 5a, the second aligning device 5b, and so forth.

In accordance with an embodiment, the aligning devices 5 comprise an emitter for emitting light and a detector for receiving light.

Also the detecting device 2 comprises a detector 10 that is sensitive to electromagnetic radiation such as light or a matrix of light detectors so that the detecting device 2 is able to capture images based on light received by the detecting device 2. In other words, the detecting device 2 may operate as a camera.

The actual structure of the actuators 3 and the aligning devices 5 may depend on the implementation of the testing arrangement 1. They may include motors, solenoids and/or other elements capable of producing mechanical force for moving the actuators 3 and the aligning devices 5. The movement may be horizontal, vertical, rotations or any combination of these, for example.

The aligning devices 5 may be electric, electronical, mechanical or optical device or device that are a combination of electrical, electronical, mechanical or optical parts.

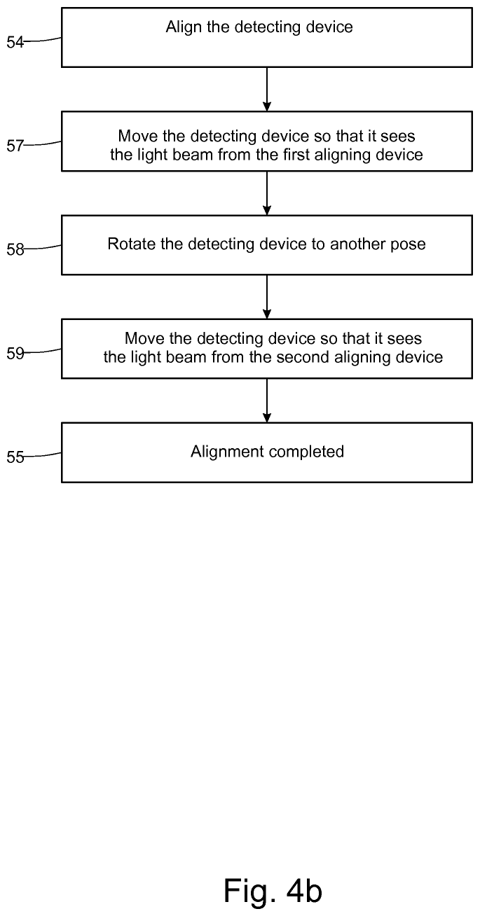

A method according to an embodiment will now be described using the arrangement of FIG. 1 as an example, with reference to the flow diagrams of FIGS. 4a and 4b and FIGS. 2a to 2d. It should be noted that the order of alignment/calibration steps presented in the following method can also be at least partly different from that order. There may also be other steps not presented in FIGS. 4a and 4b but which do not affect the actual calibration.

In a first step 51 the reference axis 8 is determined by using the reference body 4 as follows. A light beams is generated either by emitting a light beam towards the reference body 4 or if the reference body 4 comprises a light illuminator, it can be switched on to produce the light beam to be used as the reference axis 8. As was mentioned above the reference axis is not necessarily a mechanical element but a light beam.

Step 52 comprises alignment of the first aligning device 5a by moving the first aligning device 5a until it detects the light beam representing the reference axis 8. If the detecting device 2 or the second aligning device 5b is at least partly located at the reference axis so that it blocks the light beam, it is moved aside from the reference axis. This situation is illustrated in FIG. 2a.

Step 53 comprises alignment of the second aligning device 5b by moving the second aligning device 5b until it detects the light beam representing the reference axis 8. This situation is illustrated in FIG. 2b.

In accordance with an embodiment of the step 53, the second aligning device 5b is moved until it detects the light beam emitted by the first aligning device 5a wherein the second aligning device 5b need not detect the reference axis 8 because the first aligning device 5a has already been aligned with the reference axis 8.

Step 54 comprises alignment of the detecting device 2 with the first aligning device 5a and the second aligning device 5b. Details of this alignment 54 are depicted in FIG. 4b in accordance with an embodiment.

The first alignment device 5a produces a light beam 11a. The detecting device 2 is moved 57 until it detects the light beam emitted by the first aligning device 5a. This situation is illustrated in FIG. 2c.

The alignment of the detecting device 2 continues in step 58 in which the detecting device 2 is rotated a certain amount, such as 180 degrees or 90 degrees or 45 degrees, depending on the implementation. Then, a light beam 11b is produced by the second aligning device 5b and the detecting device 2 is moved in step 59 until it detects the light beam emitted by the second aligning device 5b. This situation is illustrated in FIG. 2d.

The arrangement is now completed 55, wherein the position of the detection device 2 with respect to the aligning devices 5a, 5b and also the reference axis 8 is known by the arrangement.

In the above example two aligning devices 5a, 5b were used. In accordance with another embodiment, only one aligning device 5 is used, wherein the method may comprise the following steps, illustrated in FIG. 4c. In the following, it is assumed that the first aligning device 5a is used.

In a first step 61 the reference axis 8 is determined either by emitting a light beam towards the reference body 4 or if the reference body 4 comprises a light illuminator that can be switched on to produce the reference axis 8.

Step 62 comprises alignment of the aligning device 5a by moving the aligning device 5a until it detects the light beam representing the reference axis 8.

Step 63 comprises alignment of the detecting device 2 with the aligning device 5a. This may be performed as follows, for example.

The alignment device 5a produces a light beam 11a, wherein the detecting device 2 is moved until it detects the light beam representing the reference axis 8.

The alignment of the detecting device 2 continues in step 64 in which the detecting device 2 is rotated a certain amount, such as 180 degrees or 90 degrees or 45 degrees, depending on the implementation. Then, a light beam 11b is produced by the aligning device 5a and the detecting device 2 is moved in step 65 until it detects the light beam emitted by the aligning device 5a.

The arrangement is now completed 55, wherein the position of the detection device 2 with respect to the aligning device 5a and also the reference axis 8 is known by the arrangement.

It should be noted that some of the steps described above may also comprise, although not specifically described, moving the calibrated element away from the calibration position so that the calibrated element does not block, e.g., the reference axis 8 and/or light beams emitted by the aligning devices 5.

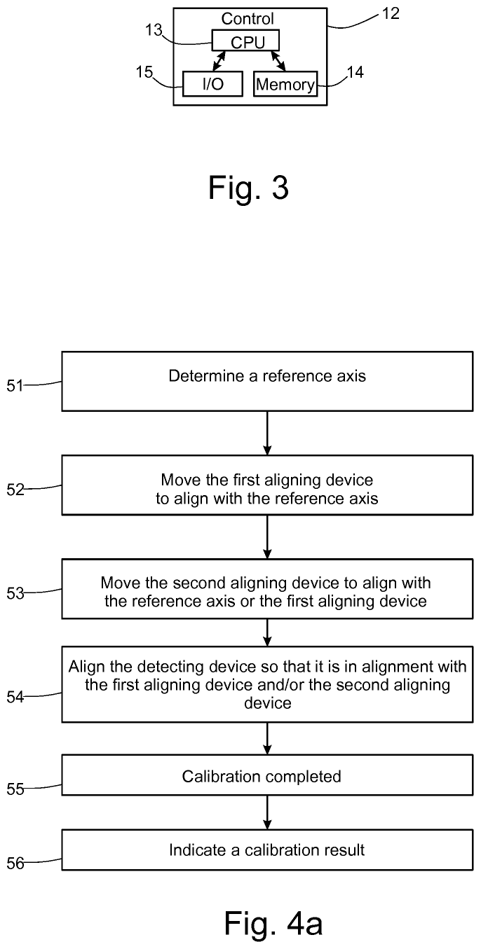

The above-mentioned calibration procedure can be implemented, for example, with a software stored into a memory 14 and executed by a processor 13 of a control device 12 (FIG. 3). Control signals to the detection device 2, actuators 3 etc. can be generated by the processor and transformed to appropriate electric signals by the input/output block 15, for example.

The control device 12 can also have a user interface 15 (e.g. a display and a keyboard) with which a user can instruct the testing apparatus 1 to perform testing and to receive information of test results.

The output of the calibration procedure may be, for example, a pass/fail type of output (step 56).

In accordance with an embodiment, the electric signals are converted to digital samples by an analogue-to-digital converter (not shown) and the samples are then provided to the control device 12. In accordance with another embodiment, the control device 12 comprises a converter which performs the conversion from analogue signals to digital samples.

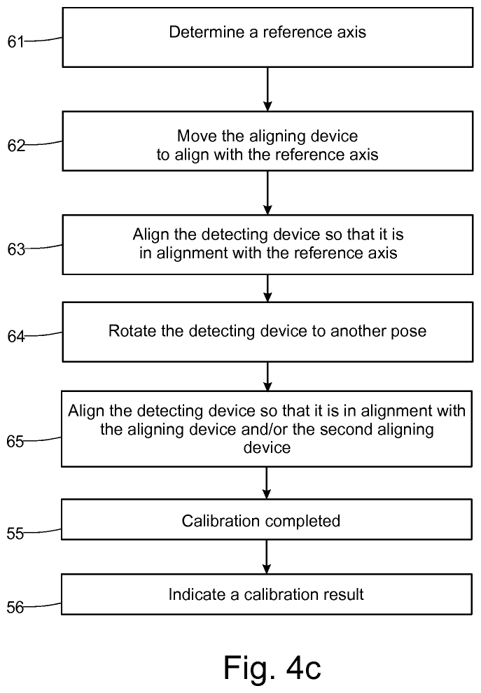

In accordance with an embodiment, after the first aligning device 5a and/or the second aligning device 5b have been aligned with the reference axis 8, the position of the first aligning device 5a and/or the second aligning device 5b may be changed e.g. by tilting, rotating and/or moving. For example, the first aligning device 5a may be tilted to a certain angle a. Hence, the first aligning device 5a may then be used to align, for example, the detection device 2 so that it is not aligned with the reference axis 8 but it is angularly (a) aligned with the reference axis. This is illustrated in FIG. 5.

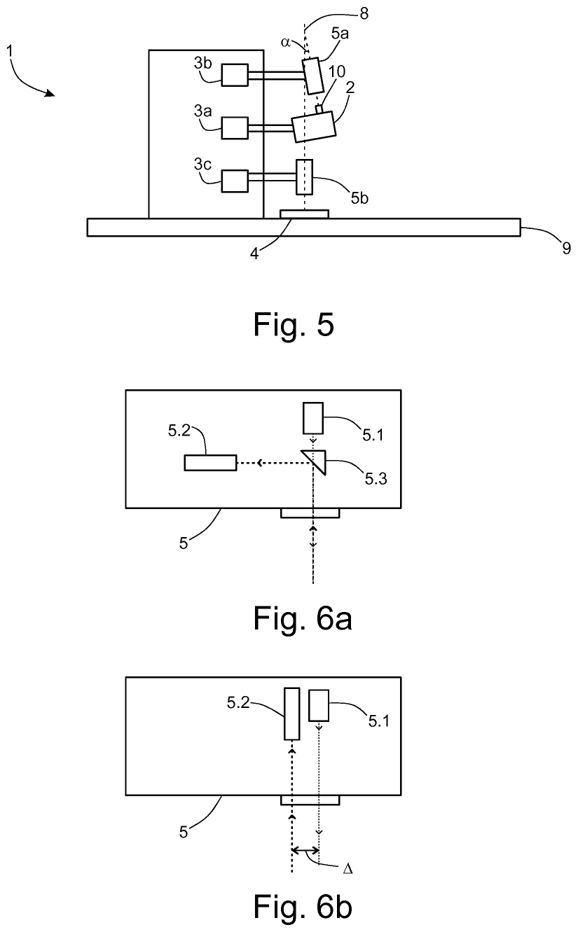

FIG. 6a illustrates in a simplified manner some details of the aligning device 5 in accordance with an embodiment, and FIG. 6b illustrates in a simplified manner some details of the aligning device 5 in accordance with another embodiment. One or more of the aligning devices 5 is, for example, an autocollimator.

In FIG. 6a the aligning device 5 comprises an emitter 5.1 for emitting light and a detector 5.2 for receiving light. There is also a semi-transparent mirror 5.3 arranged so that light beams generated by the emitter 5.1 exit from the aligning device 5 as close as possible the location at which light beams are entered to the aligning device 5. The semi-transparent mirror 5.3 directs the received light beams towards the detector 5.2 but does not change the direction of the light beams from the emitter 5.1, or vice versa, i.e. the semi-transparent mirror 5.3 changes the direction of the light beams from the emitter 5.1 but does not change the direction of the received light.

In FIG. 6b the emitter 5.1 and the detector 5.2 are arranged so that light beams generated by the emitter 5.1 exiting from the aligning device 5 and light beams entering the aligning device 5 have an offset Δ. This offset is known and can be taken into account during the alignment process e.g. as follows. When the light beam from the emitter 5.1 is reflected by the reference body 4 and when, during alignment of the aligning device 5, the reflected light beam is detected by the detector 5.2, the system knows that the correct location of the reference axis 8 is at the offset from the location where the reflected light beam is detected. In other words, the offset is either added to or subtracted from the current location.

The apparatus described above may be used, for example, to examine quality and/or other properties of a sample (not shown). The sample may be, for example, an optical waveguide. The waveguide typically comprises certain kind of optical sections on both surfaces of the waveguide. Therefore, the detecting device 2 can be moved so that both surfaces can be checked during the examination procedure. Due to the alignment process described above the location of the detecting device 2 is relatively accurately known with respect to the sample when the detecting device 2 is moved to face one side of the waveguide (e.g. above the waveguide) as well as to face the other side of the waveguide (e.g. below the waveguide). It should also be mentioned that in some embodiments two or more reference axis 8 may be formed.

In accordance with an embodiment the alignment procedure is performed to align some other device or devices in addition to the detecting device, or instead of the detecting device if the arrangement does not comprise the detecting device. The other device may be, for example, a sample holder and/or a projecting device of a testing arrangement.

1. A method for alignment by an apparatus comprising at least one aligning device, the method comprising:
determining a reference axis by a reference body;
aligning at least one aligning device with respect to the reference axis; and
aligning another device separate from the at least one aligning device with respect to the at least one aligning device.

2. The method according to claim 1 comprising:
aligning a first aligning device of the apparatus with respect to the reference axis; and
aligning a second aligning device of the apparatus with respect to the reference axis or the first aligning device.

3. The method according to claim 2 comprising:
aligning a detecting device of the apparatus with respect to at least one of the following:
the first aligning device;
the second aligning device;
the reference axis.

4. The method according to claim 1, 2 or 3 comprising:
determining the reference axis by emitting a beam of electromagnetic radiation from the reference body.

5. The method according to claim 1, 2 or 3 comprising determining the reference axis by:
emitting a beam of electromagnetic radiation from one aligning device; and
reflecting the beam of electromagnetic radiation by the reference body.

6. The method according to any of the claims 1 to 5 comprising:
using a collimated light beam as the reference axis.

7. The method according to any of the claims 1 to 6, wherein the another device is at least one of the following:
a detecting device;
a sample holder;
a projecting device.

8. An apparatus comprising at least one aligning device, the apparatus configured to
determine a reference axis by a reference body;
align at least one aligning device with respect to the reference axis; and
align another device separate from the at least one aligning device with respect to the at least one aligning device.

9. The apparatus according to claim 8, the apparatus comprising
a first aligning device;
a second aligning device;
a first actuator configured to align the first aligning device with respect to the reference axis; and
a second actuator configured to align the second aligning device with respect to the reference axis or the first aligning device.

10. The apparatus according to claim 9 comprising:
a detecting device;
a third actuator configured to align the detecting device with respect to at least one of the following:
the first aligning device;
the second aligning device;
the reference axis.

11. The apparatus according to claim 8, 9 or 10 comprising:
an emitter configured to determine the reference axis by emitting a beam of electromagnetic radiation from the reference body.

12. The apparatus according to claim 8, 9 or 10 configured to determine the reference axis by:
emitting a beam of electromagnetic radiation from one aligning device; and
reflecting the beam of electromagnetic radiation by the reference body.

13. The apparatus according to any of the claims 8 to 12 comprising:
an emitter configured to emit a collimated light beam as the reference axis.

14. The method according to any of the claims 8 to 13, wherein the another device is at least one of the following:
a detecting device;
a sample holder;
a projecting device.
